(19) United States
(12) Patent Application Publication
(10) Pub. No.: US 2026/0059190 A1
(43) Pub. Date: Feb. 26, 2026

(54) METHOD TO QUICKLY GENERATE PREVIEW THUMBNAIL AND MOBILE ELECTRONIC DEVICE

(71) Applicant: ASUSTeK COMPUTER INC., Taipei (TW)

(72) Inventors: Hsin-Chih WANG, Taipei (TW); Hsiu-Ting YANG, Taipei (TW); Yu-Hsuan LIN, Taipei (TW)

(21) Appl. No.: 19/214,183

(22) Filed: May 21, 2025

(30) Foreign Application Priority Data
Aug. 23, 2024 (TW) 113131892

(51) Int. Cl. H04N 23/63; G06T 5/70; H04N 23/741

(52) U.S. Cl. CPC H04N 23/632; G06T 5/70; H04N 23/741; G06T 2207/20182

(57) ABSTRACT

A method to quickly generate a preview thumbnail preview thumbnail and a mobile electronic device are provided. The mobile electronic device includes an image capture component, a processing device and a storage device. The method to quickly generate a preview thumbnail includes: the image capture component captures multiple frames of images according to a photographing command; the processing device optimizes the frames of images and transmits the optimized images to a camera application; the camera application selects one frame from the frames of images as a preview thumbnail; and the camera application synthesizes the frames of images to output a final image, and the final image is stored in the storage device.

### CROSS-REFERENCE TO RELATED APPLICATION

This application claims the priority benefit of Taiwan Application Serial No. 113131892, filed on Aug. 23, 2024. The entirety of the above-mentioned patent application is hereby incorporated by reference herein and made a part of specification.

### BACKGROUND OF THE INVENTION

### Field of the Invention

The invention relates to a method to quickly generate a preview thumbnail during an image-taking process and a mobile electronic device thereof.

### Description of the Related Art

When a portable electronic device, such as a mobile phone, is used to take images, preview thumbnails of the images are displayed at a camera application to show an image-taking result in real time. However, to improve a quality of captured images, a plurality of image processing algorithms are used. The captured image images are usually synthesized via the image processing algorithms, and thus the image-taking process becomes more complicated. Therefore, a time interval from a shutter button is pressed to the image is fully processed becomes longer, and the preview thumbnails are shown in delay. Consequently, the captured images cannot be shown in real time, and the image-taking experience is poor.

### BRIEF SUMMARY OF THE INVENTION

A method to quickly generate a preview thumbnail is provided. The method comprises: capturing multiple frames of images according to a photographing command; optimizing the frames of images and transmitting the optimized images to a camera application; selecting a frame from the frames of images as a preview thumbnail via the camera application; and synthesizing the frames of images to output a final image.

A mobile electronic device is provided. The mobile electronic device comprises: an image capture component adapted to capture multiple frames of images according to a photographing command; a processing device, electrically connected to the image capture component, wherein a camera application is built in the processing device, after the processing device optimizes the frames of images, the camera application selects one frame from the frames of images as a preview thumbnail, and the processing device synthesizes the frames of images to output a final image; and a storage device electrically connected to the processing device to store the final image.

In conclusion, according to a method to quickly generate a preview thumbnail and a mobile electronic device in embodiments, after images input to the image algorithms has images similar to the final image, an intermediate image is used as the preview thumbnail in advance. The time for waiting for the synthesis via the image algorithms is reduced, and the preview thumbnail is shown earlier. Therefore, unlike conventional image-taking processes, the preview thumbnail in embodiments is displayed more quickly, and the image-taking experience is better.

### BRIEF DESCRIPTION OF THE DRAWINGS

FIG. 1 is a block diagram showing a mobile electronic device according to an embodiment of the invention.

FIG. 2 is a schematic diagram showing a user interface (UI) on a touch screen of a mobile electronic device according to an embodiment of the invention.

FIG. 3 is a flow chart showing a method to quickly generate a preview thumbnail according to an embodiment of the invention.

FIG. 4 is a flow chart showing a method to quickly generate a preview thumbnail according to an embodiment of the invention.

FIG. 5 is a flow chart showing a method to quickly generate a preview thumbnail according to an embodiment of the invention.

### DETAILED DESCRIPTION OF THE EMBODIMENTS

Embodiments of the invention are illustrated accompanying diagrams, but not used to limit the invention. In addition, some components or structures are omitted in the diagrams to clearly show technical features of the invention. In the diagrams, same or similar numerals denote the same or similar components or circuits. Terms such as “first”, “second” are used to describe various components, parts, regions or functions to distinguish one component, part, region or function from another.

Thumbnails are usually used to show captured images in real time. Thumbnails occupies a relatively small proportion of a full screen of a mobile electronic device. Therefore, thumbnails only show features easy to be observed, such as a scene direction, an angle, an overall brightness, or a color of the captured image. Unlike a conventional image-taking process, in embodiments, previews are shown quickly.

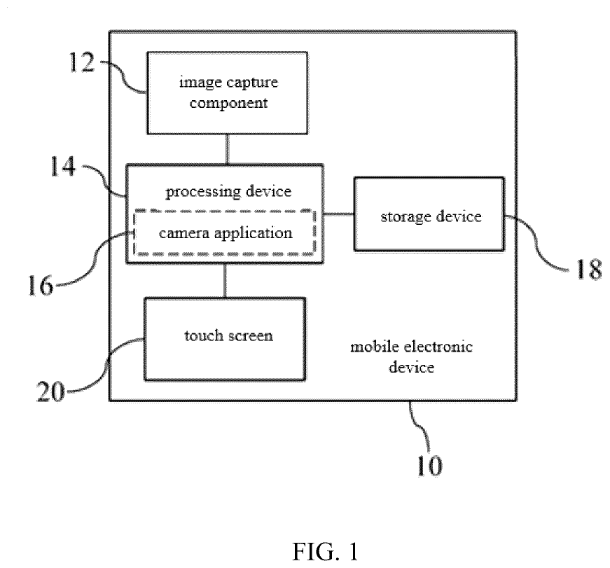

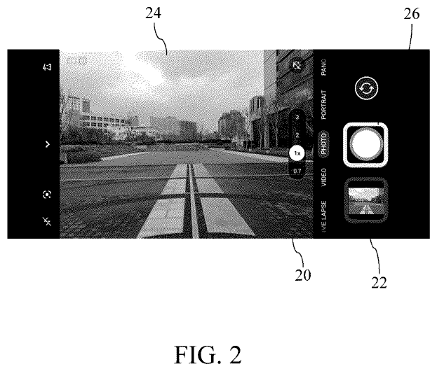

Please refer to FIG. 1 and FIG. 2. A mobile electronic device 10 includes an image capture component 12, a processing device 14, a storage device 18, and a touch screen 20. In the mobile electronic device 10, the image capture component 12 is adapted to capture multiple frames of images according to a photographing command. The processing device 14 is electrically connected to the image capture component 12 and the touch screen 20. A camera application 16 is built in the processing device 14. A plurality of image algorithms are built in the camera application 16. The processing device 14 receives the frames of images captured by the image capture component 12 and optimizes the frames of images. Then, the frames of images are transmitted to the camera application 16. The camera application 16 selects one frame from the frames of images as a preview thumbnail 22. The selected frame of the image is displayed at a preview position of a user interface (UI) 24 on the touch screen 20. The processing device 14 or the camera application 16 synthesizes the frames of images to output a final image. The storage device 18 is electrically connected to the processing device 14. The storage device 18 is adapted to store the final image output from the processing device 14. In an embodiment, the mobile electronic device 10 is a portable electronic with a processor, such as a tablet computer, a mobile phone, a Personal Digital Assistant (PDA), which is not limited herein.

In an embodiment, the processing device 14 is one or a combination of a Central Processing Unit (CPU), a general-purpose or special-purpose microprocessor, a microcontroller, a Micro Control Unit (MCU), a Digital Signal Processor (DSP), a programmable controller, and an Application Specific Integrated Circuit (ASIC), which is not limited herein.

In an embodiment, the storage device 18 is one or a combination of a fixed or a removable Random-Access Memory (RAM), a Read-Only Memory (ROM), a Flash Memory, a Hard Disk Drive (HDD), a Solid-State Drive (SSD) to store any image or image data for the processing device 14, which is not limited herein.

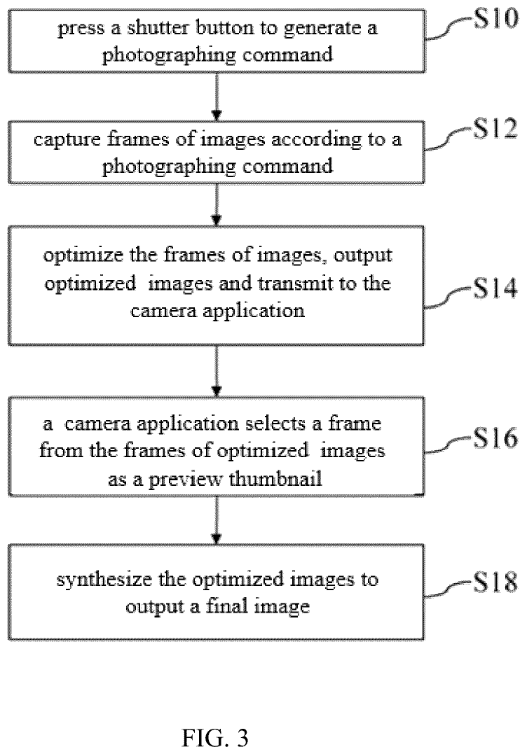

In the mobile electronic device 10, the processing device 14 executes the method in embodiments to quickly generate a preview thumbnail via the camera application 16. Please refer to FIG. 1, FIG. 2, and FIG. 3. During the preparation, a user launches the camera application 16, and a user interface (UI) 24 corresponding to the camera application 16 is shown on the touch screen 20. As shown in step S10, the user presses a shutter button 26 on the UI 24 provided by the camera application 16 to generate the photographing command to start an image-taking process. The camera application 16 selects an algorithm according to the current UI 24 to subsequently capture a single-frame image or multiple frames of images as input for the algorithm. As shown in step S12, the image capture component 12 captures the frames of images according to the photographing command to obtain the frames of images. The images are unprocessed RAW format images. After the image-taking, as shown in step S14, the processing device 14 optimizes the frames of images via an Image Signal Processing Pipeline (ISP). The ISP includes pre-processing, white balance adjustment, demosaicking, post-processing, color correction, etc. on the images to convert the RAW format images into YUV format images. Then, the frames of optimized images are output and transmitted to the camera application 16.

As shown in step S16, the camera application 16 receives all the optimized images as the input images for the image algorithms, and selects one frame of the images with the highest clarity from the optimized images as a preview thumbnail 22. In an embodiment, the camera application 16 determines the optimized image with a highest clarity via a High Pass Filter (HPF) method. Then, the determined optimized image is selected as the preview thumbnail 22 and displayed at the preview position on the UI 24 of the touch screen 20 to display the preview thumbnail 22 to users for earlier viewing. As shown in step S18, a Multiple Frame Noise Reduce (MFNR) algorithm is used to synthesize (multiple-frame synthesis) the optimized images via the camera application 16 to output the final image. The purpose of using the Multiple Frame Noise Reduce (MFNR) algorithm as the image algorithm is to execute calculations using multiple frames of optimized images to remove noises and retain details more accurately. The final image is the image-taking result stored in the storage device 18 finally. Therefore, in the embodiment, after the optimized images are obtained, one of the frames of the images is selected as the preview thumbnail 22 in advance, and thus the time for waiting for the image synthesis via the image algorithm is shorted.

In an embodiment, when the frames of images captured by the image capture component 12 have three brightness levels, after the optimization process and multi-frame synthesis and before the final image is output, the camera application 16 executes multi-brightness synthesis on the images via a High Dynamic Range (HDR) algorithm to restore a current scene by using three images at different brightness levels, and then outputs the final image.

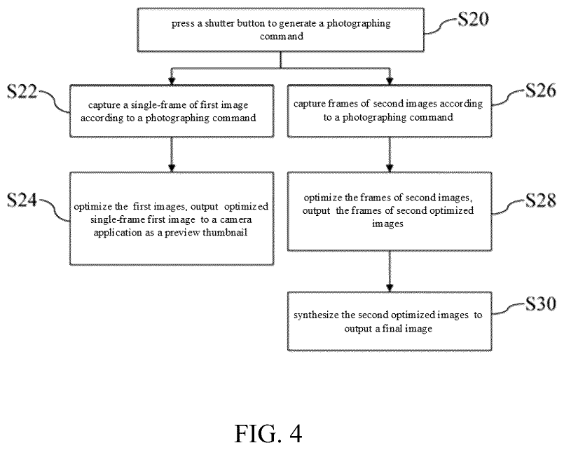

To show the preview thumbnail more quickly, in an embodiment, the images include a first image and second images. Please refer to FIG. 1, FIG. 2, and FIG. 4. As shown in step S20, when the shutter button 26 is pressed on the UI 24 of the camera application 16, a photographing command is generated to start the image-taking process. As shown in step S22, the image capture component 12 captures a single-frame first image according to the photographing command, and the first image is an unprocessed RAW format image. The captured first image is used for subsequent thumbnail display. As shown in step S24, the processing device 14 optimizes the first image. The optimization process is the ISP to convert the RAW format image into a YUV format image. Then, an optimized single-frame first image is output and transmitted to the camera application 16 as the preview thumbnail 22. Then, the preview thumbnail 22 is displayed at the preview position on the UI 24 of the touch screen 20 to the users for earlier viewing.

When the image capture component 12 receives the photographing command, except for the first image, as shown in step S26, multiple frames of second images are also captured. The second images are also unprocessed RAW format images. After the frames of second images are captured in step S26, the processing device 14 displays the preview thumbnail 22 on the UI 24. This display sequence is mainly to avoid the problem of shaking and blurring of the second images, which leads to an unsatisfactory synthesis result. Otherwise, if the preview thumbnail 22 is displayed before the frames of second images are captured, the user thinks the image-taking process is completed after seeing the preview thumbnail 22 and then moves the mobile electronic device 10. However, the second images required by the image algorithms are not captured. The captured images are blurred due to movement or shaking in the image-taking process. As shown in step S28, the processing device 14 optimizes the frames of second images. In an embodiment, the optimization process is the ISP to convert the RAW format images into YUV format images, and then the frames of second optimized images are output. As shown in step S30, the processing device 14 or the camera application 16 synthesizes the second optimized images via a multi-frame noise reduction algorithm (the image algorithm) to output the final image. When the processing device 14 synthesizes the second optimized images, after the second optimized images are generated, the second optimized images are synthesized via the multi-frame noise reduction algorithm, and then the final image is output. When the camera application 16 synthesizes the second optimized images, after the second optimized images are generated, the processing device 14 transmits the second optimized images to the camera application 16. The camera application 16 receives the second optimized images as the input images for the image algorithms in the camera application 16. The second optimized images are synthesized via the multi-frame noise reduction algorithm (the image algorithm) to output the final image. Therefore, in the embodiment, during the image-taking process, the single-frame first image is captured and set to not require additional processing via the image algorithms. When the camera application 16 obtains the first image and after the frames of second images are captured, the preview thumbnail 22 is displayed directly. In this way, the time of the image processing and subsequent synthesis via the image algorithms is not needed for the first image, and thus the preview thumbnail 22 is displayed more quickly.

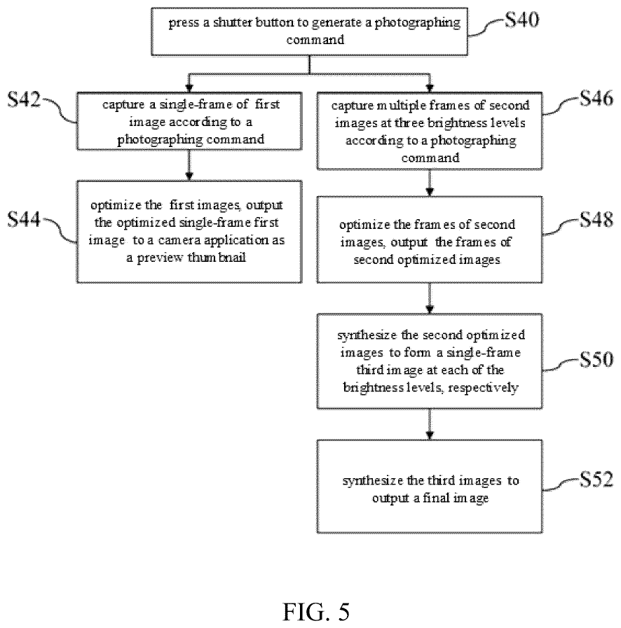

In an embodiment, different image algorithms are used according to different image-taking processes. Please refer to FIG. 1, FIG. 2 and FIG. 5. As shown in step S40, the shutter button 26 in the UI provided by the camera application 16 is pressed by a user to generate a photographing command to start the image-taking process. As shown in step S42, the image capture component 12 captures the single-frame first image according to the photographing command. The first image is an unprocessed RAW format image. As shown in step S44, the processing device 14 optimizes the first image via the ISP to convert the RAW format image into a YUV format image, and then the single-frame first optimized image is output to the camera application 16 as the preview thumbnail 22. The preview thumbnail 22 is displayed at the preview position on the UI 24 of the touch screen 20 to display the preview thumbnail 22 to the users for earlier viewing.

After the image capture component 12 captures the first image, as shown in step S46, the image capture component 12 captures multiple frames of second images at three brightness levels required by the image algorithms. The second images are also unprocessed RAW format images. As shown in step S46, the preview thumbnail 22 is displayed on the UI 24 after the frames of second images are captured to ensure clarity of the second images. After the second images are obtained, as shown in step S48, the processing device 14 executes optimization process on the second images via the ISP to convert all RAW format images into YUV format images. Then, the frames of second optimized images are output. As shown in step S50, the processing device 14 or the camera application 16 synthesizes (multi-frame synthesis) the second optimized images at the three brightness levels via the multi-frame noise reduction algorithm, respectively, to form a single-frame third image at each of the brightness levels, respectively. When the processing device 14 executes the processing, the processing device 14 synthesizes the frames of second optimized images at the three brightness levels via the multi-frame noise reduction algorithm to form a single-frame third image at each of the brightness levels, respectively. The third images are transmitted to the camera application 16. When the camera application 16 executes the processing, the processing device 14 transmits the frames of second optimized images at the three brightness levels to the camera application 16 to execute synthesis to form a single-frame third image at each of the brightness levels, respectively. As shown in step S52, after the camera application 16 obtains the third images as the input images for the image algorithms, the camera application 16 synthesizes (multi-brightness synthesis) the third images via the High Dynamic Range (HDR) algorithm to restore the current scene via the three third images at different brightness levels. Then, the final image is output. In the embodiment, the single-frame first image is captured first. The first image is processed with the optimization process (ISP) but without other image processes. Consequently, the preview thumbnail is generated more quickly, and the preview thumbnail 22 is shown earlier.

In conclusion, according to a method to quickly generate a preview thumbnail and a mobile electronic device in embodiments, after images input to the image algorithms has images similar to the final image, an intermediate image is regarded as the preview thumbnail in advance. The time for waiting for the synthesis via the image algorithms is reduced, and the preview thumbnail is shown earlier. Therefore, unlike conventional image-taking processes, the preview thumbnail in embodiments is displayed more quickly, and the image-taking experience is better.

Although the present invention has been described in considerable detail with reference to certain preferred embodiments thereof, the disclosure is not for limiting the scope of the invention. Persons having ordinary skill in the art may make various modifications and changes without departing from the scope. Therefore, the scope of the appended claims should not be limited to the description of the preferred embodiments described above.

What is claimed is:

1. A method to quickly generate a preview thumbnail, comprising:
capturing multiple frames of images according to a photographing command;
optimizing the frames of images and transmitting the optimized images to a camera application;
selecting a frame from the frames of images as a preview thumbnail via the camera application; and
synthesizing the frames of images to output a final image.

2. The method to quickly generate a preview thumbnail according to claim 1, wherein in the step of capturing multiple frames of images according to the photographing command further includes: capturing a single-frame first image; capturing multiple frames of second images; optimizing the first image and the frames of second images, transmitting the optimized first image to the camera application, and the camera application selects the first image as the preview thumbnail.

3. The method to quickly generate a preview thumbnail according to claim 2, wherein in the step of capturing multiple frames of the second images, the frames of the second images are captured at three brightness levels.

4. The method to quickly generate a preview thumbnail according to claim 3, wherein after the frames of the second images are optimized, the method further includes: synthesizing the frames of the second images at the three brightness levels via a multi-frame noise reduction algorithm to form single-frame third images at each of the brightness level, respectively, and transmitting all the third images to the camera application.

5. The method to quickly generate a preview thumbnail according to claim 4, wherein in the step of synthesizing the frames of images further includes: synthesizing the third image via a high dynamic range (HDR) algorithm to output the final image.

6. The method to quickly generate a preview thumbnail according to claim 2, wherein in the step of optimizing the first image and the frames of second images, the first image and the frames of the second images are optimized via an Image Signal Processing Pipeline (ISP).

7. The method to quickly generate a preview thumbnail according to claim 1, wherein in the step of optimizing the images, the frames of images are optimized via an Image Signal Processing Pipeline (ISP).

8. The method to quickly generate a preview thumbnail according to claim 1, wherein the camera application selects a frame of the image with a highest clarity from the frames of images as the preview thumbnail.

9. The method to quickly generate a preview thumbnail according to claim 1, wherein in the step of synthesizing the frames of images to output the final image, the images are synthesized via a multi-frame noise reduction algorithm to output the final image.

10. The method to quickly generate a preview thumbnail according to claim 1, wherein the step of synthesizing the frames of images further includes: synthesizing the frames of images via a multi-frame noise reduction algorithm and a high dynamic range (HDR) algorithm.

11. A mobile electronic device, comprising:
an image capture component adapted to capture multiple frames of images according to a photographing command;
a processing device, electrically connected to the image capture component, wherein a camera application is built in the processing device, after the processing device optimizes the frames of images, the camera application selects one frame from the frames of images as a preview thumbnail, and the processing device synthesizes the frames of images to output a final image; and
a storage device electrically connected to the processing device to store the final image.

12. The mobile electronic device according to claim 11, wherein the frames of images further includes a single-frame first image and multiple frames of second images, the image capture component captures the single-frame first image and the frames of the second images, the processing device optimizes the single-frame first image and the frames of the second images, the single-frame first image is transmitted to the camera application, and the camera application selects the first image as the preview thumbnail.

13. The mobile electronic device according to claim 12, wherein the image capture component captures the frames of the second images at three brightness levels.

14. The mobile electronic device according to claim 13, wherein the processing device synthesizes the frames the of second images at the three brightness levels via a multi-frame noise reduction algorithm to form single-frame third images at each of the brightness level, respectively, and transmits all the third images to the camera application;
or the processing device transmits the frames of the second images at the three brightness levels to the camera application and synthesizes the second images via the camera application to form single-frame third images at each of the brightness level, respectively,.

15. The mobile electronic device according to claim 14, wherein the camera application synthesizes the third images via a high dynamic range (HDR) algorithm to output the final image.

16. The mobile electronic device according to claim 12, wherein the processing device optimizes the first image and the frames of the second images via an ISP.

17. The mobile electronic device according to claim 11, wherein the processing device optimizes the images via an ISP.

18. The mobile electronic device according to claim 11, wherein the camera application selects a frame of the image with a highest clarity from the frames of images as the preview thumbnail.

19. The mobile electronic device according to claim 11, wherein the processing device synthesizes the frames of images via a multi-frame noise reduction algorithm to output the final image.

20. The mobile electronic device according to claim 11, wherein the processing device synthesizes the images to output the final image via the camera application.

21. The mobile electronic device according to claim 20, wherein the camera application synthesizes the frames of images via a multi-frame noise reduction algorithm to output the final image.
